(19) United States
(12) Patent Application Publication
(10) Pub. No.: US 2003/0072469 A1
(43) Pub. Date: Apr. 17, 2003

(54) Anti-terrorist network hardcopy mail scanning and remote viewing system and process

(76) Inventor: Ray M. Alden, Raleigh, NC (US)

Correspondence Address: Ray M. Alden, 808 Lake Brandon Trail, Raleigh, NC, 27610, US

(21) Appl. No.: 09/981,584

(22) Filed: Oct. 17, 2001

(51) Int. Cl. G06K 9/00

(52) U.S. Cl. 382/101

(57) ABSTRACT

In a preferred embodiment, a network-based hardcopy mail scanning system to enable a mail recipient to view virtual images of their mail prior to physically receiving said mail. Unwanted mail from unknown origins can be discarded remotely by the mail recipient prior to actually receiving or touching the hardcopy mail. Thus the mail recipient is insulated from contact with potential letter bombs, biological agents, and chemical agents distributed by terrorists through the US or international postal systems. The process includes a means to digitize an image of hardcopy mail intended for a mail recipient, a database to store the digitized image, a scanning service computer connected to said database. Said scanning service computer and a mail recipient computer are interconnected by a computer network. The scanning service computer communicates images of hardcopy mail (addressed for delivery to the mail recipient) to the mail recipient computer via the computer network. The mail recipient can elect to accept mail for receipt or to reject mail which is then destroyed. By virtually selecting what mail to accept and discarding the rest, the recipient can discard mail from unknown origins prior to ever physically handling it.

### BACKGROUND FIELD OF INVENTION

This invention relates to insulating a hardcopy mail recipient from receiving unwanted mail articles. More specifically, a mail scanning and digital image storing process is disclosed wherein a scanning service computer sends digital images of an intended mail recipient's hardcopy mail to the intended recipient's computer. Said scanning service computer and said intended mail recipient's computer being interconnected by a computer network. The intended mail recipient views images of his mail remotely via his computer and sends signals via computer electing which pieces to receive and which pieces to discard. The scanning service computer receives the intended recipient's elections. The scanning service mails the hardcopy mail for which acceptance has been indicated and discards mail for which rejection has been indicated. The intended recipient can also instruct (via computer) the scanning service to open and scan (capture the image of) the contents of a particular mail piece. This process enables a mail recipient to further pre-select which mail he wishes to receive and which he wishes to discard. By discarding unwanted mail in advance of actual receipt, this process reduces an intended mail recipient's potential exposure to explosives, biological agents, and chemical agents that terrorists may attempt to distribute to the intended recipient through the US and international postal systems.

### BACKGROUND-DESCRIPTION OF PRIOR INVENTION

The US postal system was one of the earliest institutions established in the young United States of America as an open means of communication between vast numbers of mail senders and mail receives. The US postal system has served the US well and has been emulated in many other countries. Unfortunately, in recent years, terrorists have used our postal system to distribute exploding letters, anthrax, and other biological and chemical agents with the intention of harming mail recipients. Presently, recipients are warned to exercise caution when opening and handling mail. Some precautions include, don't open mail from an unknown recipient or mail which has wires in it, for example. These instructions provide some useful benefit but little comfort to mail recipients. A primary exposure still exists for the recipient who physically filters through potential mail hazards. Namely, a chemical or biological agent could potentially be on the outside of the envelope. While the prior art does not provide a means for individual mail recipients to filter out unwanted mail (such as mail from unknown origins) prior to actually physically receiving it, the present invention provides a digital image means to achieve this object.

Capturing and distributing digital images has been brought to a fine art in recent decades. Likewise high speed mail handling, metering, routing and distribution equipment has been well known and widely used for decades. The process for automatically digitizing the image of a hardcopy mail article and sending the image to the article's intended recipient via networked computers and enabling the user to select whether or not to receive the mail article without having physically handled the article has not been anticipated in the prior art. The present invention discloses this novel and unanticipated process and system.

### SUMMARY

This invention relates to insulating a hardcopy mail recipient from receiving unwanted mail articles. More specifically, a mail scanning and digital image storing process is disclosed wherein a scanning service computer sends digital images of an intended mail recipient's mail to the intended recipient's computer. Said scanning service computer and said intended mail recipient's computer being interconnected by a computer network. The intended mail recipient views images of his mail remotely via his computer and sends signals via computer electing which pieces to receive and which pieces to discard. The scanning service computer receives the intended recipient's elections. The scanning service mails the hardcopy mail for which acceptance has been indicated and discards mail for which rejection has been indicated. The intended recipient can also instruct (via computer) the scanning service to open and scan (capture the image of) the contents of a particular mail piece. This process enables a mail recipient to pre-select which mail he wishes to receive and which he wishes to discard. By discarding unwanted mail in advance of actual receipt, this process reduces an intended mail recipient's potential exposure to explosives, biological agents, and chemical agents that terrorists may attempt to distribute to the intended recipient through the US and international postal systems.

### OBJECTS AND ADVANTAGES

Accordingly, several objects and advantages of the present invention are apparent. It is an object of the present invention to provide a means for intended hardcopy mail recipients to select which mail articles they wish to receive and which they wish to discard without their having to physically handle articles. It is an object of the present invention to thereby dramatically reduce an intended mail recipient's potential exposure to terrorist weapons such as explosives, biological agents, and chemical agents. It is an advantage of the present invention that a service is provided to digitally record the image of the intended recipient's mail. It is an advantage that the image is sent from said service's computer to said intended recipient's computer via a network. It is an advantage that said recipient can decide which mail to receive and which mail to discard based upon the digital images. It is an advantage that the user's computer sends elections to the scanning service's computer via a network such that the scanning service can exercise the intended recipient's elections. It is an advantage that the scanning service sends only the hardcopy mail wanted by the intended recipient. It is an advantage of the present invention that unwanted mail is discarded by the scanning service prior to ever being received by its intended recipient. Thus the object of minimizing unwanted mail and minimizing concomitant potential for terrorist exposures are dramatically achieved by the present invention.

### DRAWING FIGURES

FIG. 1 prior art is a flowchart describing the typical home hardcopy mail stream in the US.

FIG. 2 prior art is a flowchart describing the typical office hardcopy mail stream in the US.

FIG. 3 is a flowchart describing hardcopy mail interception at the home mailbox.

FIG. 4 is a flowchart describing hardcopy mail scanning via a service address.

FIG. 5 is a flowchart describing hardcopy mail scanning performed by the US Postal Service.

FIG. 6 is a flowchart describing hardcopy mail scanning performed by an office mail processing system.

FIG. 7 illustrates the computers interconnected by network.

FIG. 8 is a flowchart illustrating hardcopy mail flow integrated with the computers interconnected by network.

FIG. 9 illustrates the GUI with an image received by the intended hardcopy recipient.

### DESCRIPTION

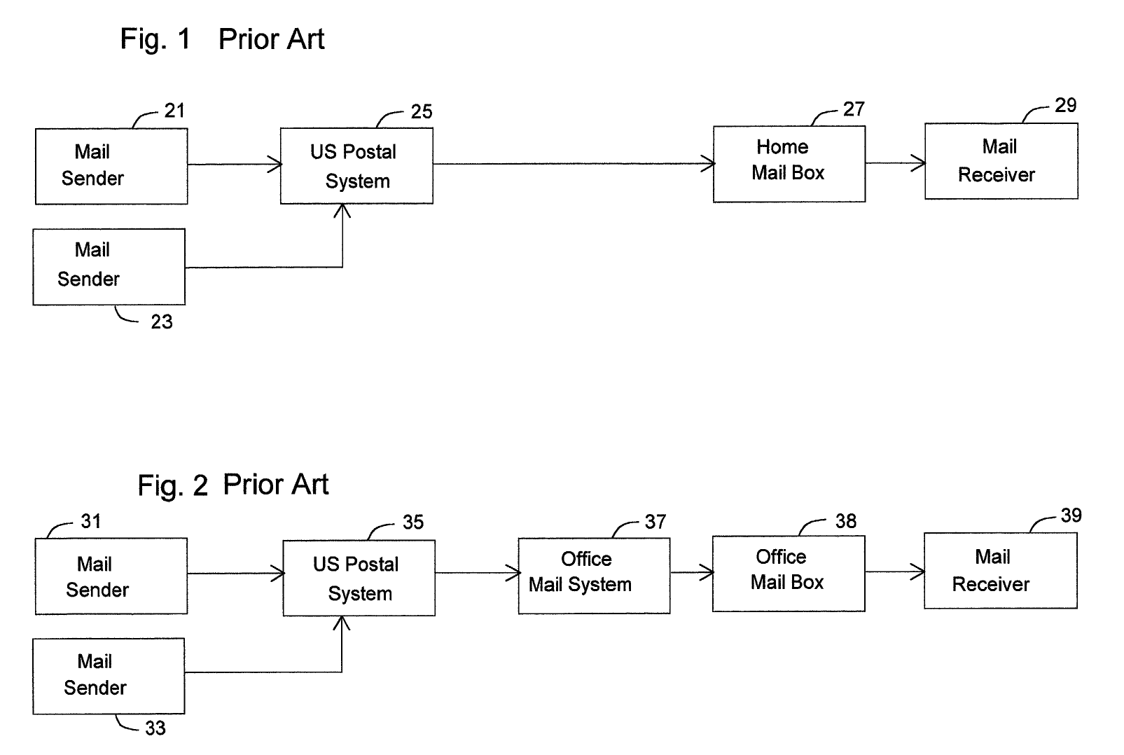

FIG. 1 prior art is a flowchart describing the typical home hardcopy mail stream in the US. A vast number of potential mail senders exist in the modem worldwide postal system. Some mail sender's are known to a mail recipient 29, many other's are unknown. A first mail sender 21 and a second mail sender 23 each send mail through a US Postal System 25. Under the present system, the mail receiver has no control whatsoever as to which mail he will receive or not receive. Thus the mail recipient must be prepared to deal with mail from anyone including terrorists which may arrive any day at his home mail box 27.

FIG. 2 prior art is a flowchart describing the typical office hardcopy mail stream in the US. Similarly to FIG. 1, a vast number of potential mail senders exist in the modem worldwide postal system. Some mail sender's are known to the mail recipient many other's are unknown. Under the present system, the mail receiver has no control whatsoever as to which mail he will receive or not receive. Thus a mail recipient 39 must be prepared to deal with mail from anyone including terrorists which may arrive any day at his office mail box 38 courtesy of his office mail distribution system 37.

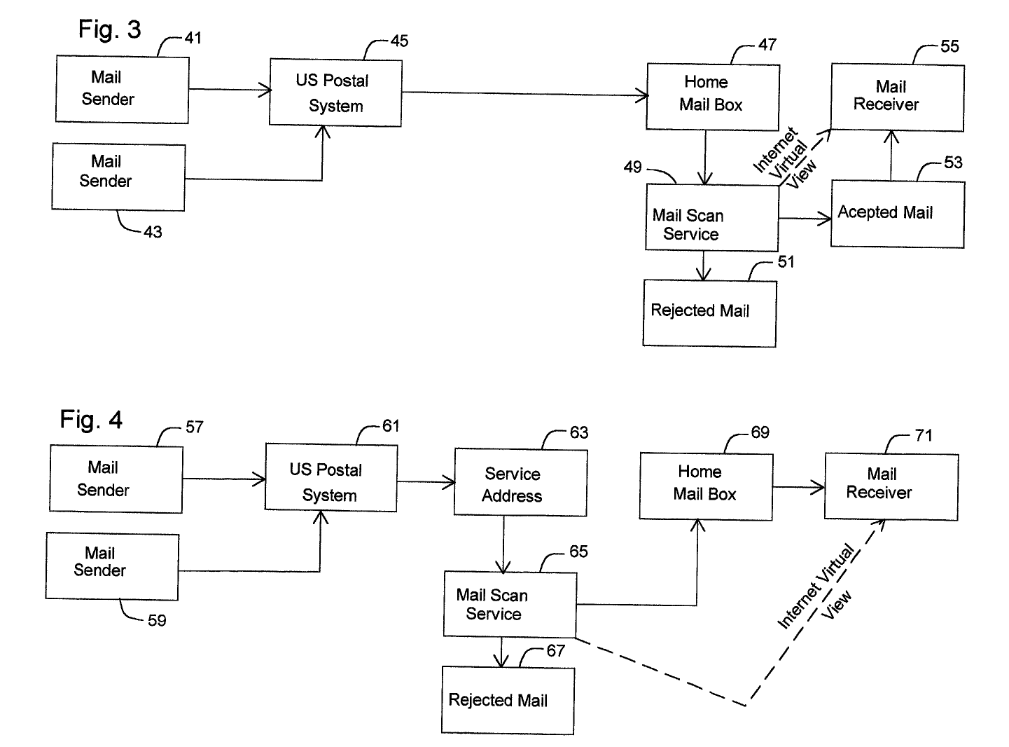

FIG. 3 is a flowchart describing hardcopy mail interception at the home mailbox of the present invention. The present invention provides a mail scan service 49. In this illustration, the mail scan service is intercepting the intended recipient's 55 mail at his home mail box 47. The 49 scans (records a digital image) of the mail which it provides electronically over the internet, thereby enabling the intended recipient to virtually view the mail prior to receiving it. Internet communication channel between 49 and 55 is indicated by a dotted line. The 55 elects to accept or to reject each specific mail article. Rejected mail 51 is discarded by the 49 and accepted mail 53 is routed to the user by the 49. Thus the user of the scanning service receives and personally handles only the mail that he wishes to and discards the unwanted mail without ever having handled it. This reduces potential for exposure to explosives, biological agents, and chemical agents distributed by terrorists.

FIG. 4 is a flowchart describing hardcopy mail scanning via a service address. FIG. 4 provides an alternate, more efficient, process than FIG. 3. A mail receiver 71 officially changes his mailing address to a service address location 63. Thus all mail intended for the recipient goes to the service address for processing. A mail scan service 65 records digital images of the mail which it sends by computer over the internet to an intended mail receiver's computer 71. Internet communication channel between 65 and 71 is indicated by a dotted line. The intended receiver elects which pieces to accept and which to reject. His computer notifies the 65 computer of these elections via the internet. The 65 accordingly discards rejected mail 67 and sends to the intended recipient's home mail box 69 only accepted mail. Thus the user of the scanning service receives and personally handles only the mail that he wishes to and discards the unwanted mail without ever having handled it. This reduces potential for exposure to explosives, biological agents, and chemical agents distributed by terrorists.

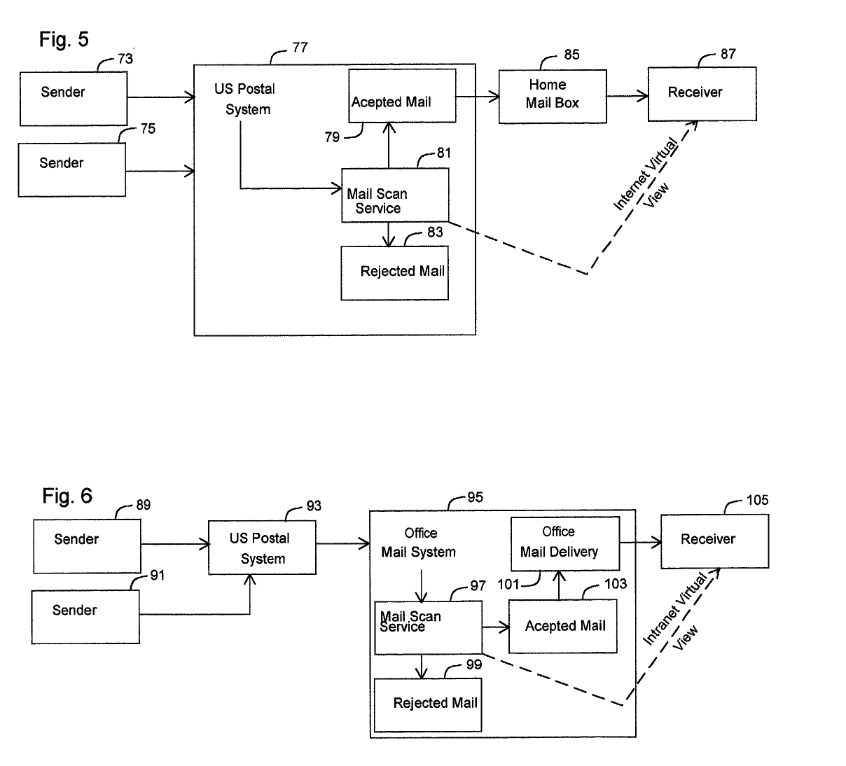

FIG. 5 is a flowchart describing hardcopy mail scanning of the present invention if performed by the US Postal Service. After the postal service 77 receives the mail from multiple senders, it provides a mail scanning service (digital images of the mail are created). An intended receiver 87 is given access to the digital images via the internet (indicated with dotted line) which interconnects the 87 computer and the 81 computer. Also over the internet, the 87 sends elections to accept or reject each mail article to the 81 computer. The Postal Service then delivers only the accepted mail to a home mailbox 85 and discards the rejected mail. Thus the user of the US Postal scanning service receives and personally handles only the mail that he wishes to and discards the unwanted mail without ever having handled it. The scanning service thus reduces the user's (mail recipient's) potential for exposure to explosives, biological agents, and chemical agents distributed by terrorists.

FIG. 6 is a flowchart describing hardcopy mail scanning performed by an office mail processing system. Many buildings use internal mailroom personnel to distribute mail through out the building, the present invention can be used at the building level as well. After the postal service 93 delivers mail to an office mail processing system 95, the office mail service provides a mail scanning service (digital images of the mail are created). An intended receiver 105 is given access to the digital images via the intranet (indicated with dotted line) which interconnects the 97 computer and the 105 computer. Also over the intranet, the 105 sends elections to accept or reject each mail article to the 97 computer. The office mail processing system then delivers only the accepted mail to the 105 and discards the rejected mail. Thus the user of the office mail scanning service receives and personally handles only the mail that he wishes to and discards the unwanted mail without ever having handled it. This reduces potential for exposure to explosives, biological agents, and chemical agents distributed by terrorists.

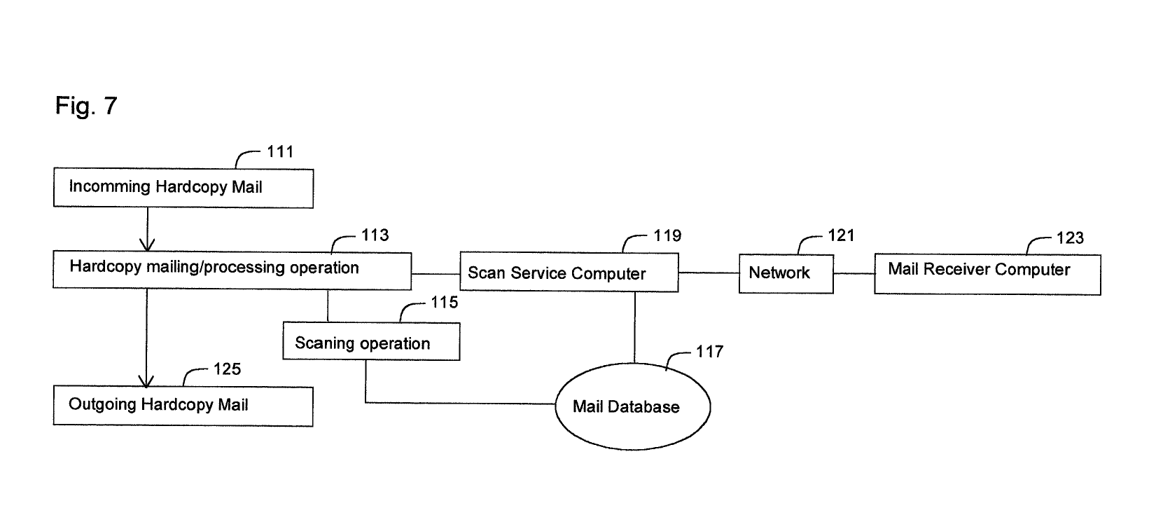

FIG. 7 illustrates the computers interconnected by network. The scanning service or hardcopy mail processing operation 113 receives incoming mail 111. It scans the mail (creates digital images) in a scanning operation 115. Images are stored in a mail database 117. Images from the 117 are served to a mail receiver computer 123 via a scan service computer 119, both computers being interconnected by a network 121. The 123 sends elections to 119 concerning what to do with each mail article. The 119 stores these elections in the 117 and sends processing instructions to the 113. Mail is process according to the 123 instructions including some sent out to the 123 as outgoing hardcopy mail 125.

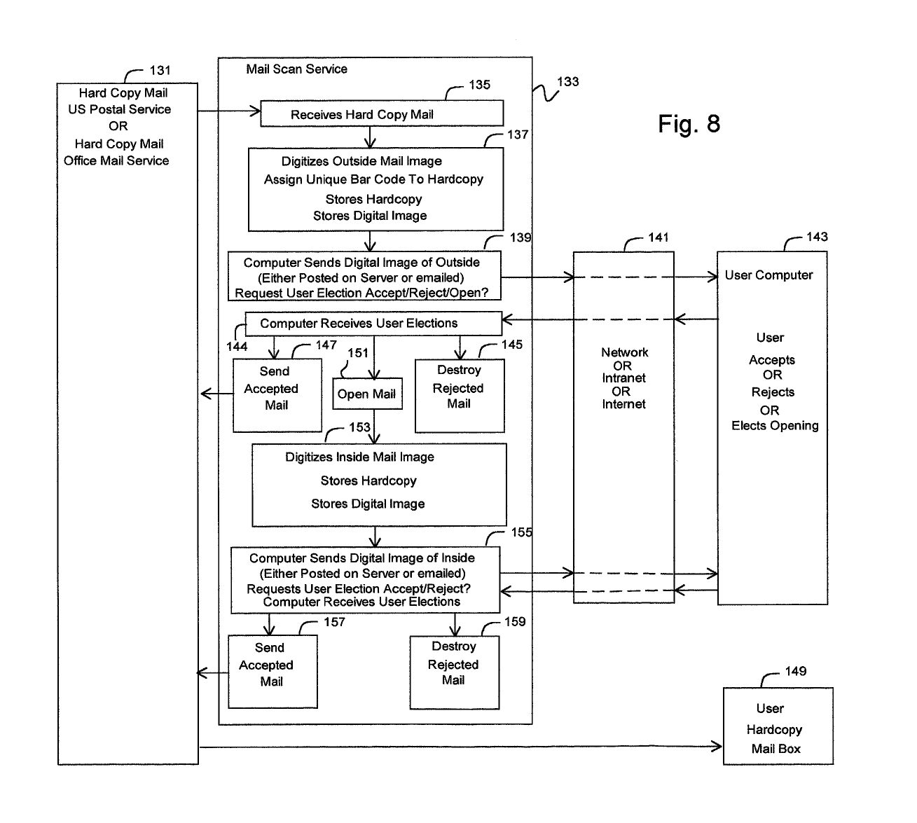

FIG. 8 is a flowchart illustrating hardcopy mail flow integrated with the computers interconnected by network. Hardcopy mail 131 is received by a mail scan service 133 as received hardcopy mail 135. As its first processing, hardcopy mail is scanned (digital images are created), assigned a barcode number, stored, and its digital image is stored at 137. A computer 139 sends digital images to the mails intended recipient at user computer 143 via a network 141. The 143 computer sends elections back to the 139 computer at the message received box 144 (via the network 141). The 144 computer sends instructions for handling of each mail article according to the 143 10 elections. Accepted mail 147 is sent through the internal (office or building mail system) and/or external (postal service) system where the hardcopy mail is given to the user hardcopy mail box 149. Mail rejected by 143 is rejected mail 145 and is destroyed. The 143 user can opt for other processing options as well one such option is to open the mail 151. Opened mail is itself recorded to a digital image 153. This opened mail image is sent to the user at 155. Again the user 143 is given the option to accept or reject via the network connection. The user elects options and the processing service either sends accepted mail 157 or destroys rejected mail 159. Thus the user of the scanning service receives only mail that he elects to receive. This significantly reduces his potential risk to mail delivered terrorist weapons.

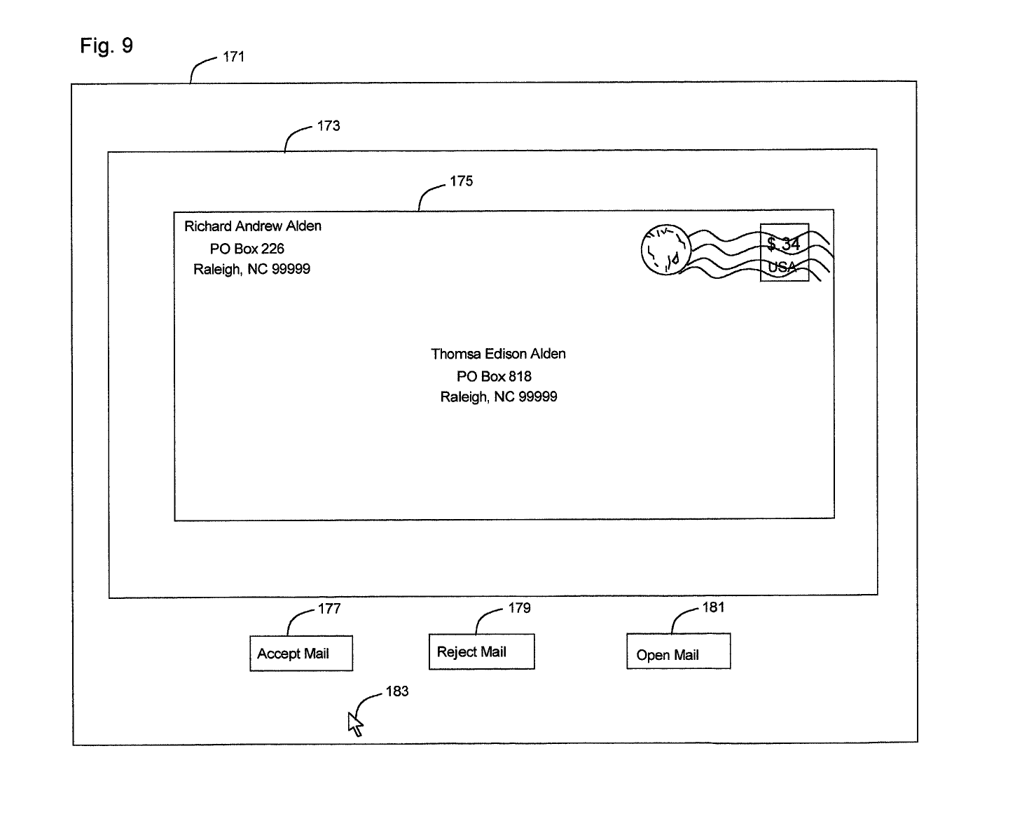

FIG. 9 illustrates the GUI with an image received by the intended hardcopy recipient. This is a representation of what the scanning service computer sends to the mail recipients computer via the network. A graphical user interface (GUI) 171 contains two basic areas. A first area is the image view area 173. It contains the image of an envelope 175 that was received by the scanning service which digitally recorded its image and sent it over the internet to a user of the scanning service. If the user wants to receive the mail, he uses his curser arrow 183 to click on the accept mail icon 177. The user can also click on a reject mail icon 179 to reject the mail or an open mail icon 181 to further inspect the mail's content. The instructions are sent to the scanning service for execution via the network connect. Thus the user of the scanning service receives only mail that he elects to receive. This significantly reduces his potential risk to mail delivered terrorist weapons.

Operation of the Invention

FIG. 1 prior art is a flowchart describing the typical home hardcopy mail stream in the US. A vast number of potential mail senders exist in the modern worldwide postal system. Some mail sender's are known to a mail recipient 29, many other's are unknown. A first mail sender 21 and a second mail sender 23 each send mail through a US Postal System 25. Under the present system, the mail receiver has no control whatsoever as to which mail he will receive or not receive. Thus the mail recipient must be prepared to deal with mail from anyone including terrorists which may arrive any day at his home mail box 27.

FIG. 2 prior art is a flowchart describing the typical office hardcopy mail stream in the US. Similarly to FIG. 1, a vast number of potential mail senders exist in the modem worldwide postal system. Some mail sender's are known to the mail recipient many other's are unknown. Under the present system, the mail receiver has no control whatsoever as to which mail he will receive or not receive. Thus a mail recipient 39 must be prepared to deal with mail from anyone including terrorists which may arrive any day at his office mail box 38 courtesy of his office mail distribution system 37.

FIG. 3 is a flowchart describing hardcopy mail interception at the home mailbox of the present invention. The present invention provides a mail scan service 49. In this illustration, the mail scan service is intercepting the intended recipient's 55 mail at his home mail box 47. The 49 scans (records a digital image) of the mail which it provides electronically over the internet, thereby enabling the intended recipient to virtually view the mail prior to receiving it. Internet communication channel between 49 and 55 is indicated by a dotted line. The 55 elects to accept or to reject each specific mail article. Rejected mail 51 is discarded by the 49 and accepted mail 53 is routed to the user by the 49. Thus the user of the scanning service receives and personally handles only the mail that he wishes to and discards the unwanted mail without ever having handled it. This reduces potential for exposure to explosives, biological agents, and chemical agents distributed by terrorists.

FIG. 4 is a flowchart describing hardcopy mail scanning via a service address. FIG. 4 provides an alternate, more efficient, process than FIG. 3. A mail receiver 71 officially changes his mailing address to a service address location 63. Thus all mail intended for the recipient goes to the service address for processing. A mail scan service 65 records digital images of the mail which it sends by computer over the internet to an intended mail receiver's computer 71. Internet communication channel between 65 and 71 is indicated by a dotted line. The intended receiver elects which pieces to accept and which to reject. His computer notifies the 65 computer of these elections via the internet. The 65 accordingly discards rejected mail 67 and sends to the intended recipient's home mail box 69 only accepted mail. Thus the user of the scanning service receives and personally handles only the mail that he wishes to and discards the unwanted mail without ever having handled it. This reduces potential for exposure to explosives, biological agents, and chemical agents distributed by terrorists.

FIG. 5 is a flowchart describing hardcopy mail scanning of the present invention if performed by the US Postal Service. After the postal service 77 receives the mail from multiple senders, it provides a mail scanning service (digital images of the mail are created). An intended receiver 87 is given access to the digital images via the internet (indicated with dotted line) which interconnects the 87 computer and the 81 computer. Also over the internet, the 87 sends elections to accept or reject each mail article to the 81 computer. The Postal Service then delivers only the accepted mail to a home mailbox 85 and discards the rejected mail. Thus the user of the US Postal scanning service receives and personally handles only the mail that he wishes to and discards the unwanted mail without ever having handled it. The scanning service thus reduces the user's (mail recipient's) potential for exposure to explosives, biological agents, and chemical agents distributed by terrorists.

FIG. 6 is a flowchart describing hardcopy mail scanning performed by an office mail processing system. Many buildings use internal mailroom personnel to distribute mail through out the building, the present invention can be used at the building level as well. After the postal service 93 delivers mail to an office mail processing system 95, the office mail service provides a mail scanning service (digital images of the mail are created). An intended receiver 105 is given access to the digital images via the intranet (indicated with dotted line) which interconnects the 97 computer and the 105 computer. Also over the intranet, the 105 sends elections to accept or reject each mail article to the 97 computer. The office mail processing system then delivers only the accepted mail to the 105 and discards the rejected mail. Thus the user of the office mail scanning service receives and personally handles only the mail that he wishes to and discards the unwanted mail without ever having handled it. This reduces potential for exposure to explosives, biological agents, and chemical agents distributed by terrorists.

FIG. 7 illustrates the computers interconnected by network. The scanning service or hardcopy mail processing operation 113 receives incoming mail 111. It scans the mail (creates digital images) in a scanning operation 115. Images are stored in a mail database 117. Images from the 117 are served to a mail receiver computer 123 via a scan service computer 119, both computers being interconnected by a network 121. The 123 sends elections to 119 concerning what to do with each mail article. The 119 stores these elections in the 117 and sends processing instructions to the 113. Mail is process according to the 123 instructions including some sent out to the 123 as outgoing hardcopy mail 125.

FIG. 8 is a flowchart illustrating hardcopy mail flow integrated with the computers interconnected by network. Hardcopy mail 131 is received by a mail scan service 133 as received hardcopy mail 135. As its first processing, hardcopy mail is scanned (digital images are created), assigned a barcode number, stored, and its digital image is stored at 137. A computer 139 sends digital images to the mails intended recipient at user computer 143 via a network 141. The 143 computer sends elections back to the 139 computer at the message received box 144 (via the network 141). The 144 computer sends instructions for handling of each mail article according to the 143 elections. Accepted mail 147 is sent through the internal (office or building mail system) and/or external (postal service) system where the hardcopy mail is given to the user hardcopy mail box 149. Mail rejected by 143 is rejected mail 145 and is destroyed. The 143 user can opt for other processing options as well, one such option is to open the mail 151. Opened mail is itself recorded to a digital image 153. This opened mail image is sent to the user at 155. Again the user 143 is given the option to accept or reject via the network connection. The user elects options and the processing service either sends accepted mail 157 or destroys rejected mail 159. Thus the user of the scanning service receives only mail that he elects to receive. This significantly reduces his potential risk to mail delivered terrorist weapons.

FIG. 9 illustrates the GUI with an image received by the intended hardcopy recipient. This is a representation of what the scanning service computer sends to the mail recipients computer via the network. A graphical user interface (GUI) 171 contains two basic areas. A first area is the image view area 173. It contains the image of an envelope 175 that was received by the scanning service which digitally recorded its image and sent it over the internet to a user of the scanning service. If the user wants to receive the mail, he uses his curser arrow 183 to click on the accept mail icon 177. The user can also click on a reject mail icon 179 to reject the mail or an open mail icon 181 to further inspect the mail's content. The instructions are sent to the scanning service for execution via the network connect. Thus the user of the scanning service receives only mail that he elects to receive. This significantly reduces his potential risk to mail delivered terrorist weapons.

Conclusions, Ramifications, and Scope

Accordingly, several objects and advantages of my invention are apparent.

Accordingly, several objects and advantages of the present invention are apparent. It is an object of the present invention to provide a means for intended hardcopy mail recipients to select which mail articles they wish to receive and which they wish to discard without their having to physically handle articles. It is an object of the present invention to thereby dramatically reduce an intended mail recipient's potential exposure to terrorist weapons such as explosives, biological agents, and chemical agents. It is an advantage of the present invention that a service is provided to digitally record the image of the intended recipient's mail. It is an advantage that the image is sent from said service's computer to said intended recipient's computer via a network. It is an advantage that said recipient can decide which mail to receive and which mail to discard based upon the digital images. It is an advantage that the user's computer sends elections to the scanning service's computer via a network such that the scanning service can exercise the intended recipient's elections. It is an advantage that the scanning service sends only the hardcopy mail wanted by the intended recipient. It is an advantage of the present invention that unwanted mail is discarded by the scanning service prior to ever being received by its intended recipient. Thus the object of minimizing unwanted mail and minimizing concomitant potential for terrorist exposures are dramatically achieved by the present invention.

It should be noted that other configurations are possible using the art described herein. While my above description describes many specifications, these should not be construed as limitations on the scope of the invention, but rather as an exemplification of one preferred embodiment thereof Many other variations are possible. For example, many means of digitizing images are well known and are not described herein. Many means for physically processing, storing and routing mail are well known and are not described herein. Many software programming languages can be used and one skilled in the art can easily compose the necessary software and GUI's.

I claim:

1. A method of selecting which hardcopy mail is to be received by an intended mail recipient comprising;
a digital means for sending images of said intended recipient's mail to said intended recipient, and
a means for said recipient to view said images, wherein
said digital means for sending images and said means to view said images are interconnected by a network.
